(19) United States
(12) Patent Application Publication
(10) Pub. No.: US 2024/0011411 A1
(43) Pub. Date: Jan. 11, 2024

(54) TURBINE-GENERATOR ASSEMBLY WITH MAGNETIC COUPLING

(71) Applicant: CLIMEON AB, Kista (SE)

(72) Inventors: Per ASKEBJER, Åkersberga (SE); Fredrik ÖHRNELL, Nacka (SE)

(73) Assignee: CLIMEON AB, Kista (SE)

(21) Appl. No.: 18/254,105

(22) PCT Filed: Nov. 22, 2021
(86) PCT No.: PCT/SE2021/051162

§ 371 Date: May 23, 2023

(30) Foreign Application Priority Data
Nov. 27, 2020 (SE) 2051385-9

(51) Int. Cl. F01D 15/10; F01D 25/22; H02K 49/10

(52) U.S. Cl. CPC F01D 15/10; F01D 25/22; H02K 49/106; F05D 2220/76; F05D 2240/53; F05D 2260/404

(57) ABSTRACT

A turbine (10) configured to operate in a thermodynamic cycle comprising a working fluid circuit, wherein the turbine comprises an impeller (11) mounted on a first end (20a) of a turbine shaft (20), the impeller being arranged in a housing (12) with a turbine inlet (10a) for the working fluid, wherein a second end (20b) of the turbine shaft is connectable to a shaft of a generator (60) by means of a magnetic coupling (40) for transferring torque from the turbine shaft to the generator shaft, wherein a fluid tight barrier (50) is mounted on the turbine, covering the turbine shaft to seal the turbine from the surroundings, wherein the turbine further comprises at least one fluid bearing (30a, 30b, 30c) arranged on the turbine shaft and in fluid communication with the working fluid circuit to receive working fluid therefrom.

### TECHNICAL FIELD

The invention relates to a turbine and a turbine-generator assembly comprising a magnetic coupling.

### BACKGROUND ART

Turbines are essential elements used in power production in power plants run by thermodynamic power cycles such as the Rankine cycle, Kalina cycle, Carbon Carrier cycle and/or Carnot cycle. In such power plants, a working fluid in liquid state is heated until it is converted into a gas which then enters a turbine to perform work. The turbine is in turn coupled to a generator via a shaft to convert the rotation of the turbine into electrical energy.

However, due to the physical connection between the turbine and the generator, there can be considerable leakage of the working fluid driving the turbine into the generator. Consequently, the generator rotor must be adapted to run fully immersed in the working fluid. Additionally, the bearings on the turbine shaft must also be configured to operate immersed in the working fluid. Another problem encountered is that the working fluid chosen may be explosive and therefore requires rigorous safety measures in accordance with ATEX directives (EU minimum safety requirements of the workplace and equipment used in explosive atmosphere), as well as special adaptations of the generator and associated electronics to prevent accidents. Finally, high operating temperatures of the working fluid also affect the generator. As a result, thermodynamic power cycles often require custom-built generators which drive cost and limit the operation modes of the turbine.

One solution that has been proposed is to introduce a magnetic coupling between the turbine and the generator wherein the connection can be sealed to eliminate leakage of working fluid. In this way the generator can operate in air and the problem with ATEX for the generator is eliminated and a simpler bearing solution could be implemented.

The problem with such a solution is that the turbine still rotates with a high speed and needs sophisticated bearings. Examples of such magnetic couplings are disclosed in EP 3 495 677 A1 and WO 2019/054280 A1, which also propose static gas bearings wherein pressurised gas is introduced into the gap between the bearing faces, i.e. the rotating shaft and the surrounding bearing housing. Since there is no contact between the moving parts, there is no sliding friction, allowing gas or fluid bearings to have lower friction, wear and vibration than many other types of bearings. It is even possible for some fluid bearings to have near-zero wear if operated correctly. However, such gas bearings require a shaft position control system, which adjusts the gas pressure and consumption according to the rotation speed and shaft load. Additionally, a separate gas source and pump is necessary to externally supply the pressurised gas to the bearing.

JP H02-50055 A discloses a Rankine cycle engine driven compression refrigerator with a combined compressor and an expander connected by a magnetic coupling covered by a common casing. The shafts of the compressor and the expander are supported by gas bearings. The Rankine cycle driving the expander uses water as working fluid which is boiled in a boiler and superheated in a superheater before entering the expander. A separate conduit feeds boiled but not superheated steam from the Rankine cycle to the gas bearing of the expander. This bearing steam is then led to a space adjacent the compressor which carries the risk of transferring heat from the expander to the compressor, which affects the refrigerant in the compression refrigeration cycle negatively.

Therefore, solutions are needed for overcoming the disadvantages associated with the known turbines.

### SUMMARY OF INVENTION

An object of the present invention is to provide an improved apparatus and method for overcoming all or some of the disadvantages and problems described above in connection with the state of the art.

This object is achieved by the present invention, wherein in a first aspect there is provided a turbine configured to operate in a thermodynamic cycle comprising a circuit for a working fluid, wherein the turbine comprises an impeller mounted on a first end of a turbine shaft, the impeller being arranged in a housing with a turbine inlet for the working fluid to impart rotation on the impeller, wherein a second end of the turbine shaft comprises a plurality of magnets mounted thereon to form part of a magnetic coupling arranged to connect the turbine shaft to a shaft of a generator for transferring torque from the turbine shaft to the generator rotor shaft, wherein a fluid tight barrier is mounted on the turbine, enclosing the turbine shaft and the magnets to seal the turbine from the surroundings, wherein the turbine further comprises at least one fluid bearing arranged on the turbine shaft, wherein the at least one fluid bearing is arranged in fluid communication with the working fluid circuit to receive working fluid therefrom to act as pressurised fluid for the at least one fluid bearing.

By providing fluid communication between the circuit for the working fluid in the thermodynamic cycle and the at least one fluid bearing, the fluid bearing will run on the working fluid of the thermodynamic cycle. Thus, the need for a separate source and pump to supply pressurised fluid to the fluid bearing is obviated. Additionally, since any turbine will experience some leakage of working fluid from the impeller housing, the turbine shaft will generally be immersed in the working fluid. Because the fluid bearing is already adapted to run on the working fluid, it does not require any additional adaptation or sealing to ensure compatibility with the working fluid. Finally, the fluid tight barrier provides a hermetically sealed encapsulation of the turbine to prevent any working fluid from leaking out. Thus, a standalone turbine with a fluid bearing supplied by the working fluid driving the turbine is achieved, which may be coupled with a generator for torque transfer via a magnetic coupling in a simple, leak-free manner without requiring additional sealing means.

In one embodiment, the turbine comprises a conduit between the turbine inlet and the at least one fluid bearing to provide the fluid communication. By means of the conduit, a simple solution for conveying the working fluid to the fluid bearing is achieved. Additionally, the pressure of the working fluid in the fluid bearing will be substantially equal to the pressure in turbine inlet, thereby balancing the axial thrust forces on the turbine shaft.

In one embodiment, the turbine further comprises a stator plate arranged between the impeller and the fluid tight barrier, wherein the conduit is arranged in the stator plate. By machining the conduit in the stator plate, a compact and robust solution for conveying the working fluid to the fluid bearing is achieved, without requiring additional piping.

In one embodiment, the at least one fluid bearing is further arranged in fluid communication with an outlet of the impeller housing. This arrangement ensures that the pressure drop of the working fluid is substantially the same, regardless of whether the working fluid passes through the impeller housing to perform work and expand, or through the at least one fluid bearing to act as pressurised bearing fluid. Preferably, the turbine shaft is hollow to provide the fluid communication between the at least one fluid bearing and the outlet of the impeller housing. This arrangement provides a simple solution for the return path of the bearing fluid.

In one embodiment, the mass of the magnets is adapted to the mass of the impeller to balance the turbine shaft. By adapting the mass of the magnets and the impeller to each other, the turbine shaft will be substantially balanced and the radial forces acting on the fluid bearing will only be gravity, i.e. no tilting or bending forces. Thereby, the loads that the fluid bearing must compensate are reduced.

In one embodiment, the turbine further comprises a buffer tank arranged between and in fluid communication with the working fluid circuit and the at least one fluid bearing. The buffer tank serves as a reservoir for providing pressurised fluid to the fluid bearing during start-up and stop/emergency shutdown of the turbine.

In a second aspect of the present disclosure, there is provided a turbine-generator assembly comprising a turbine according to the first aspect, and a generator comprising a generator shaft with a coupling element and a plurality of magnets mounted thereon to form part of the magnetic coupling, the generator being connected to the turbine by means of the magnetic coupling.

In one embodiment, the magnetic coupling is a magnetic gear having a non-unity gear ratio between the turbine shaft and the generator rotor shaft. The magnetic gear allows for different rotational speed of the turbine and the generator such that each may operate in its optimal rotation regime.

### BRIEF DESCRIPTION OF DRAWINGS

The invention is now described, by way of example, with reference to the accompanying drawings, in which

FIG. 1 shows a cross-sectional view of a turbine-generator assembly according to one embodiment of the present disclosure;

FIG. 2 shows a perspective view of a turbine according to one embodiment of the present disclosure;

FIG. 3 shows a cross-sectional view of a turbine according to one embodiment of the present disclosure;

FIG. 4 shows a cross-sectional view of a magnetic coupling used with a turbine according to one embodiment of the present disclosure;

FIG. 5 shows schematic view of a buffer tank in conjunction with a turbine according to one embodiment of the present disclosure; and

### DESCRIPTION OF EMBODIMENTS

In the following, a detailed description of a turbine according to the present disclosure is presented. In the drawing figures, like reference numerals designate identical or corresponding elements throughout the several figures. It will be appreciated that these figures are for illustration only and are not in any way restricting the scope of the invention.

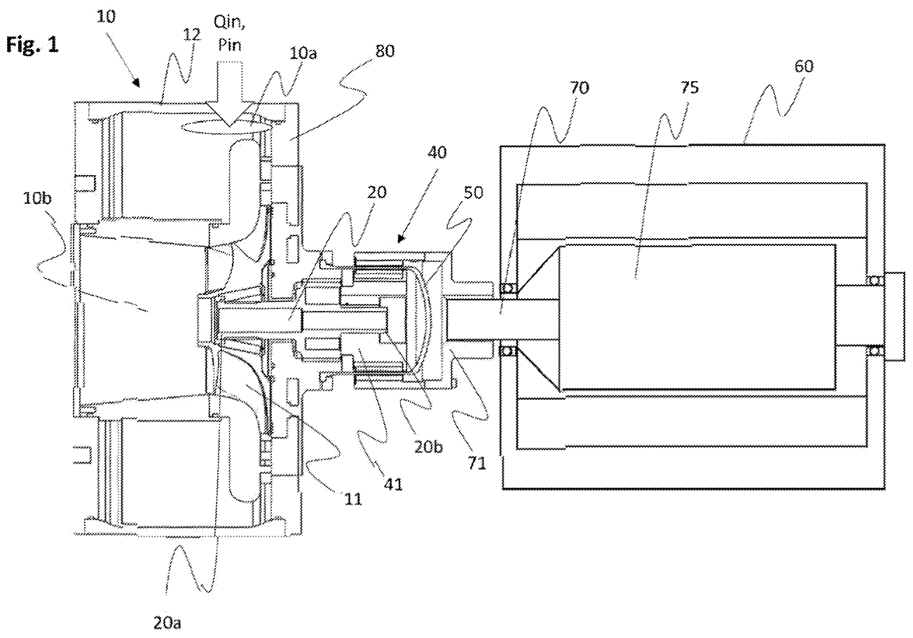

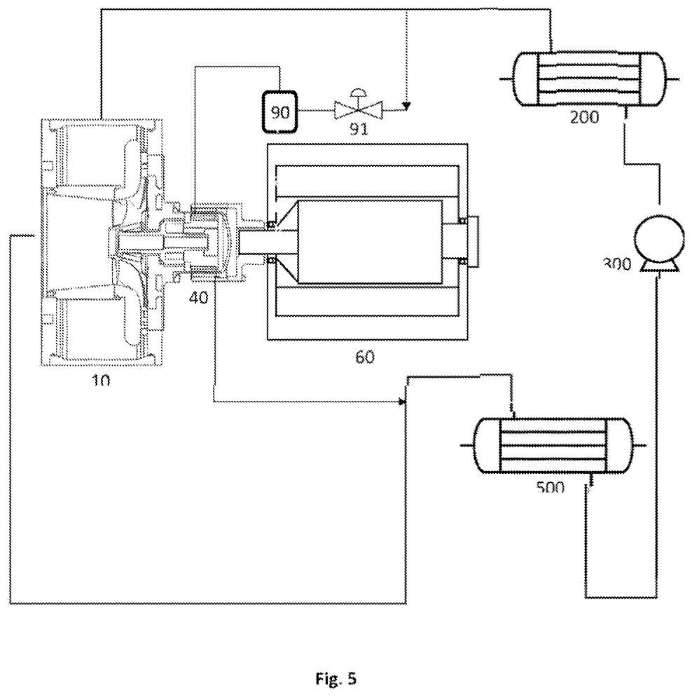

Referring to FIG. 1, there is illustrated a turbine 10 according to one embodiment of the present disclosure connected to a generator 60 by means of a magnetic coupling 40. The turbine 10 is configured to operate in a thermodynamic cycle, such as a (organic) Rankine cycle, comprising a working fluid circuit (not shown), to convert thermal energy to mechanical energy which may be used e.g. to drive the rotor 75 of the generator 60 to produce electrical energy. To this end, the thermodynamic cycle comprises a pump for circulating the working fluid in the working fluid circuit, a heat source, and a cold sink, see also FIG. 5.

The turbine 10 comprises an impeller 11 mounted on a first end 20a of a turbine shaft 20 with the impeller 11 being arranged in an impeller housing 12 with a turbine inlet 10a for the working fluid from the working fluid circuit. The working fluid enters the impeller housing 12 through the turbine inlet 10a at high temperature and pressure to impart rotation on the impeller 11. In the exemplary embodiment shown in FIG. 1, the turbine 10 is a radial turbine and the flow of the working fluid is oriented perpendicular to the rotation axis of the turbine shaft 20, as indicated by the arrow. However, other types of turbines such as for example axial turbines are also applicable. As the working fluid imparts rotation on the impeller 11, it expands and flows towards a turbine outlet 10b, which in FIG. 1 is arranged centrally, substantially concentric with the rotation axis of the turbine shaft 20.

At an opposite, second end of the turbine shaft 20b there is provided a magnetic coupling 40 in the form of a plurality of magnets mounted thereon, as will be further explained below. The plurality of magnets are distributed around the circumference of the turbine shaft 20 and configured to cooperate with a corresponding pattern of magnets on a rotor associated with or connected to the generator 60 in order to transfer torque between the turbine shaft 20 and the generator rotor 75 via the generator rotor shaft 70. In the embodiment shown in FIG. 1, the turbine shaft 20 comprises an internal rotor 41, and the generator rotor shaft 70 comprises an external coupling element 71 surrounding the turbine shaft 20. However, it is foreseen that the turbine shaft 20 may be comprise an external rotor and the generator rotor shaft 70 may comprise an internal rotor, depending on the parameters affecting the magnetic coupling 40.

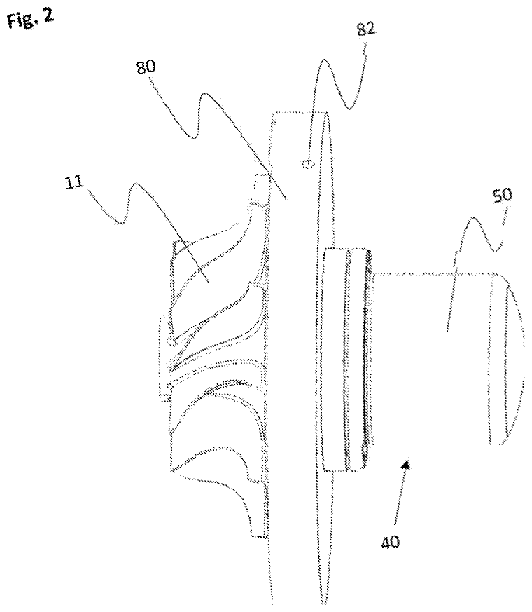

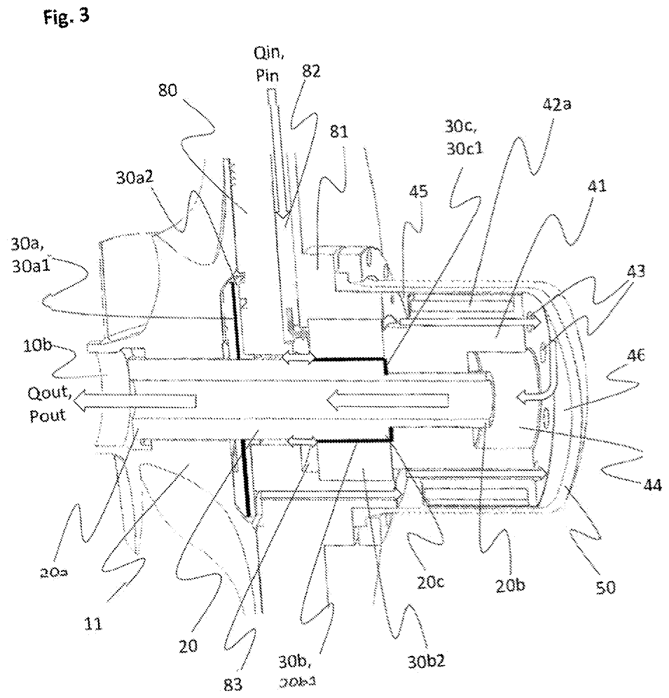

To seal the turbine 10 from the surroundings, there is provided a fluid tight physical barrier 50 mounted on the turbine 10 and enclosing the second end 20b of the turbine shaft 20. The physical barrier 50 may be a shroud, or a cup made of a thermoplastic, ceramic and/or metallic alloy material, preferably exhibiting high mechanical and chemical resistance properties over a wide temperature range. Examples of suitable materials include polyether ether ketone (PEEK) and Hastelloy®. As may be seen in the embodiment in FIGS. 2 and 3, a substantially cylindrical shroud 50 open in one end and with a convex base is mounted on the turbine, covering the turbine shaft 20 and magnets 42a to provide a substantially hermetically sealed encapsulation of the turbine 10 and thereby prevent any leakage of working fluid from the turbine 10 to the surroundings, e.g. to the generator 60.

In order to support the turbine shaft 20, the turbine 10 comprises at least one fluid bearing 30a, 30b, 30c that provides a thin layer of pressurised fluid between associated bearing surfaces. Preferably, the fluid bearing is hydrostatic or aerostatic in that the pressurised fluid is supplied from an external source, as opposed to hydrodynamic or aerodynamic wherein bearing rotation sucks fluid onto the inner surface of the bearing.

As previously discussed, the present disclosure proposes a solution wherein the working fluid of the thermodynamic cycle driving the turbine 10 is simultaneously used as the pressurised fluid for the at least one fluid bearing 30a, 30b, 30c. To this end the fluid bearing 30a, 30c is arranged in fluid communication with the working fluid circuit. For instance, part of the working fluid may be diverted from the circuit downstream of the hot source heat exchanger 200 (see FIG. 5) and fed to the at least one fluid bearing 30a, 30b, 30c. In this way, the working fluid reaching the fluid bearings 30a, 30b, 30c will have substantially the same temperature and pressure as the working fluid entering the impeller housing 12 at the turbine inlet 10a. Some of the advantages achieved by the proposed solution are that the need for an external supply and pump for pressurising the bearing fluid is obviated, the fluid bearings 30a, 30b, 30c need not be adapted to operate in the presence of different fluids (i.e. due to leakage of working fluid from the turbine), and the axial thrust on the impeller 11 due to the pressure of the working fluid in the impeller housing 12 can be balanced by the pressure of the working fluid used as pressurised bearing fluid.

In one embodiment, fluid communication between the working fluid circuit and the at least one fluid bearing 30a, 30b, 30c is achieved by means of a conduit 82 arranged between the turbine inlet 10a and the fluid bearing 30a, 30b, 30c. Referring now to FIGS. 2 and 3, a supply conduit 82 is machined in a stator plate 80 which is arranged adjacent the impeller 11 and forms the back wall of the impeller housing 12. As may be seen in FIG. 3, the conduit 82 debouches in a circumferential inlet cavity 83, from which the working fluid is further distributed to the fluid bearings 30a, 30b, 30c. The turbine shaft 20 passes through a central opening of the stator plate 80. In this embodiment, there is provided three fluid bearings 30a, 30b, 30c supplied by the working fluid through the conduit 82, two axial bearings 30a, 30c and one radial bearing 30b. However, any number of axial and/or radial fluid bearings is foreseen in conjunction with the present disclosure.

A first axial fluid bearing 30a is arranged between the impeller 11 and the stator plate 80. The working fluid is introduced under pressure into a slit 30a1 formed by a static bearing surface 30a2 and a rear surface of the rotating impeller 11, opposite the impeller blades. The static bearing surface 30a2 may be in the form of a flat, circular disc attached to the stator plate 80.

The radial fluid bearing 30b is arranged between the stator plate 80 and the magnetic coupling 40 and comprises a stationary radial bearing housing 30b2 with a circular opening for receiving the turbine shaft 20 therethrough. The working fluid is introduced under pressure into the gap between the inner surface of the opening and the external surface of the turbine shaft 20 to form a thin fluid film between the bearing surfaces. The radial bearing housing 30b2 is attached to a flange 81 of the stator plate 80 extending towards the second end 20b of the turbine shaft 20.

A second axial fluid bearing 30c is realised by means of a gap 30c1 formed between a shoulder 20c of the turbine shaft 20 and the rotor element 41 of the magnetic coupling 40 attached to the second end 20b of the turbine shaft 20. The working fluid is introduced under pressure into the gap 30c1 to form a thin fluid film between the two bearing surfaces.

During operation of the turbine 10, a pressure difference over the impeller 11 arises as the working fluid expands, pushing the impeller 11 in a direction towards the turbine outlet 10b. However, the pressure Pᵢₙ at the turbine inlet 10a is higher than the pressure in the impeller housing 12, at the back of the impeller 11. Because of the fluid communication from the turbine inlet 10a through the conduit 82 to the inlet cavity 83, the axial force resulting from the pressure Pᵢₙ acting on the circular surface of the cavity 83 is greater than the force from the expanded working fluid in the impeller housing 12 acting on the rear surface of the impeller 11. This will cause the turbine shaft 20 to move in a direction towards the magnetic coupling 40. The first axial fluid bearing 30a compensates axial movement in this direction, whereas the second axial fluid bearing 30c compensates axial movement in the opposite direction. Thus, the axial fluid bearing(s) 30a, 30c together achieve a self-regulating system, wherein the turbine shaft 20 will move axially until the gaps in the axial fluid bearing(s) 30a, 30c attain a width which balances the axial forces.

In one embodiment, the turbine shaft 20 is hollow to provide a return pathway for the working fluid between the second and first ends 20b, 20a. More particularly, as may be seen in FIG. 3, the magnetic coupling 40 comprises a rotor element 41 attached to the turbine shaft 20 adjacent the second end 20b thereof, and the plurality of magnets 42 are mounted around the circumference of the rotor element 41. The diameter of the rotor element 41 is stepped such that adjacent the radial fluid bearing housing 30b2, the diameter is smaller than the inner diameter of the shroud 50, thus forming a first cavity 45. Adjacent the second end 20b of the turbine shaft, the diameter of the rotor element 41 together with the magnets 42 mounted thereon substantially corresponds to, i.e. is slightly smaller than, the inner diameter of the shroud 50. In this region, the rotor element 41 comprises a plurality of through-going longitudinal channels 43, substantially parallel to the rotation axis of the turbine shaft 20. The channels 43 provide fluid communication between the first cavity 45 and an end face of the rotor element 41 adjacent the convex base of the shroud 50. A central bore 44 extends through the rotor element 41 such that the hollow turbine shaft 20 mounted therein debouches in a second cavity 46 delimited by the end face of the rotor element and the interior surface of the shroud 50. Together, the cavities 45, 46, the channels 43 and the interior bore of the turbine shaft 20 form a pathway for the working fluid from the fluid bearings 30a, 30b, 30c to the outlet 10b of the turbine 10.

One advantage with this arrangement is that it ensures that the inlet pressure Pᵢₙ and outlet pressure Pₒᵤₜ, respectively, of the working fluid is substantially the same regardless of which path the working fluid follows therebetween, i.e. passing the impeller 11 or the fluid bearings 30a, 30b, 30c. As a result, the forces acting on the impeller 11 in the axial direction caused by the inlet pressure Pᵢₙ of the working fluid at the turbine inlet 10a will be counteracted by substantially the same pressure of the working fluid in the one or more axial fluid bearings 30c supporting the turbine shaft 20. Thereby, an improved balancing of the turbine shaft 20 is achieved without the need for external pumps or fluid supply for the fluid bearings 30a, 30b, 30c.

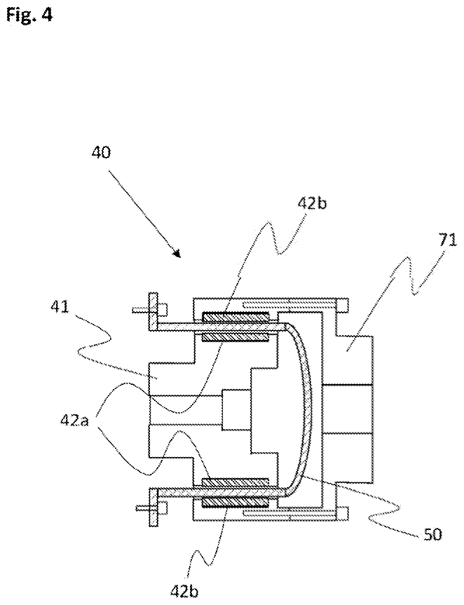

Referring now to FIG. 4, there is shown a cross-sectional view of an exemplary magnetic coupling 40 arranged to magnetically couple the turbine 10 with a generator 60 to form a turbine-generator assembly according to a second aspect of the present disclosure. The magnetic coupling 40 is formed by a first set of magnets 42a mounted on the (inner) rotor 41 of the turbine, and a second set of magnets 42b mounted on an (outer) coupling element 71 arranged to be attached to the shaft 70 of the generator 60. As discussed above, a containment shroud 50 providing a fluid tight barrier for sealing the turbine 10, is arranged between the first and second sets of magnets 42a, 42b and mounted on the turbine, e.g. by means of bolts. The shroud 50 prevents leakage of working fluid from the turbine 10 to the generator 60, thereby enabling the turbine 10 to operate with any suitable commercially available off-the-shelf (COTS) generator without requiring special adaptations, e.g. of generator electronics. Additionally, the process temperatures of the thermodynamic cycle are decoupled from the generator, which enables high process temperatures without risking damage or suboptimal performance of the generator. Another advantage with the magnetic coupling 40 is that since the magnets 42a, 42b do not come into physical contact with each other, there is no wear of magnetically coupled surfaces and the surfaces may slip in relation to each other without causing damage.

In one embodiment, the magnetic coupling 40 constitutes a magnetic gear which provides a non-unity gear ratio between the inner and outer rotor. In other words, the mechanical gear allows different rotational speeds of the turbine 10 and the generator 60 such that each may operate in its optimal rotation regime. A lower speed generator generally requires less complex and expensive power electronics.

The magnetic gear comprises, in addition to the first and second plurality of magnets 42a, 42b, an intermediate ferromagnetic pole stator (not shown) to modulate the magnetic fields produced by the plurality of magnets 42a, 42b on the inner rotor 41 and outer coupling element 71, respectively. The pole stator may comprise a plurality of pole pieces (not shown) distributed about the circumference of the inner rotor 41 or outer coupling element 71. The gear ratio is determined by the ratio between the number of magnets in each set or array 42a, 42b on the inner rotor 41 and outer coupling element 71, respectively. The magnetic gear may include permanent magnets and/or electromagnets, the latter allowing for adjustable gear ratios without removal/addition of magnets.

Referring now to FIG. 5, there is shown a schematic view illustrating the working principle of an exemplary power generation module. Said power generation module is arranged to convert low-temperature heat into electricity by utilizing the phase change energy of a working fluid produced in a thermodynamic cycle. The thermodynamic closed loop cycle may be a Rankine cycle, Organic Rankine Cycle, Kalina cycle or any other known thermodynamic closed loop power generating processes converting heat into power. The power generation module comprises the turbine 10, a generator 60, a hot source (HS) heat exchanger 200, cold source (CS) heat exchanger 500, and a pump 300, and a working fluid is circulated through the module. The pump 300 in the power generation module is located downstream of the CS heat exchanger 500. The working fluid is heated in the HS heat exchanger 200, also called evaporator, to vaporisation by an incoming hot source. The hot gaseous working fluid is then passed to the turbine 10 which drives the generator 60 for production of electrical energy. The expanded hot working fluid, still in gaseous form, is then led to the CS heat exchanger 500 to be converted back to liquid form before being recirculated to the HS heat exchanger 200 to complete the closed-loop cycle.

Still referring to FIG. 5, there is also shown an embodiment wherein a buffer tank 90 is connected in fluid communication between the working fluid circuit and the fluid bearings of the turbine 10. The buffer tank 90 serves as a reservoir for working fluid for the fluid bearings to ensure sufficient pressure during start-up and stop or emergency shutdown sequences of the turbine-generator assembly. The fluid communication between the buffer tank 90 and the fluid bearings of the turbine 10 is here shown as a separate conduit for clarity. Naturally, the buffer tank 90 may also be fluidly connected to the turbine inlet 10a or directly to the conduit 82 in the stator plate 80 discussed above. Additionally, a separate conduit is shown draining bearing fluid from the magnetic coupling 40 to the CS heat exchanger 500, but this may alternatively be achieved via the return path through the hollow turbine shaft 20 and the turbine outlet 10b as explained above.

An exemplary start-up sequence may be carried out as follows. Initially, a variable-frequency drive (VFD) controls the rotation of the turbine 10 to hold it stationary. The bearing material in the fluid bearings 30a, 30b, 30c is adapted to tolerate a small amount of rotation without pressurised fluid. A heat source (not shown) is supplied to the (HS) heat exchanger 200 such that the temperature of the working fluid increases. Next a control valve 91 at the inlet of the buffer tank 90 is opened and at the same time a small amount of working fluid is led to the HS heat exchanger 200. This leads to an increase in pressure of the working fluid at the outlet of the HS heat exchanger 200 which then fills the buffer tank 90 and flows through the fluid bearings 30b, 30c. The pressure is allowed to build up until a sufficiently high pressure is achieved to activate the fluid bearings 30a, 30b, 30c, i.e. levitate the bearing surfaces 30a1, 30b1, 30c1. At this time, the turbine 10 can start rotating. Preferably, the valve 91 is controlled by a programmable logic controller (PLC).

An exemplary stop or emergency shutdown sequence is basically carried out in the opposite order. First, the control valve 91 is closed to prevent the buffer tank 90 from losing pressure as the pump 300 in the thermodynamic cycle is stopped. Rotation of the turbine 10 is stopped while maintaining supply and pressure of the working fluid to the fluid bearings 30a, 30b, 30c from the buffer tank 90. To this end, the buffer tank 90 is dimensioned to hold a sufficient amount of working fluid depending on the specifications and requirements of the turbine 10, i.e. how long time it takes to stop rotation of the turbine 10.

Preferred embodiments of a turbine and turbine-generator assembly have been disclosed above. However, a person skilled in the art realises that this can be varied within the scope of the appended claims without departing from the inventive idea.

All the described alternative embodiments above or parts of an embodiment can be freely combined or employed separately from each other without departing from the inventive idea as long as the combination is not contradictory.

1-9. (canceled)

10. A turbine configured to operate in a thermodynamic cycle comprising a working fluid circuit, wherein the turbine comprises an impeller mounted on a first end of a turbine shaft, the impeller being arranged in a housing with a turbine inlet for the working fluid to impart rotation on the impeller, wherein a second end of the turbine shaft comprises a plurality of magnets mounted thereon to form part of a magnetic coupling arranged to connect the turbine shaft to a shaft of a generator for transferring torque from the turbine shaft to the generator shaft, wherein a fluid tight barrier is mounted on the turbine, enclosing the turbine shaft and the magnets to seal the turbine from the surroundings, wherein the turbine further comprises at least one fluid bearing arranged on the turbine shaft, wherein the at least one fluid bearing is arranged in fluid communication with the working fluid circuit to receive working fluid therefrom to act as pressurised fluid for the at least one fluid bearing.

11. The turbine according to claim 10, wherein the turbine comprises a conduit between the turbine inlet and the at least one fluid bearing to provide the fluid communication.

12. The turbine according to claim 11, further comprising a stator plate arranged between the impeller and the fluid tight barrier, wherein the conduit is arranged in the stator plate.

13. The turbine according to claim 10, wherein the at least one fluid bearing is further arranged in fluid communication with an outlet of the impeller housing.

14. The turbine according to claim 13, wherein the turbine shaft is hollow to provide the fluid communication between the at least one fluid bearing and the outlet of the impeller housing.

15. The turbine according to claim 10, wherein the mass of the plurality of magnets is adapted to the mass of the impeller to balance the turbine shaft.

16. The turbine according to claim 10, further comprising a buffer tank arranged between and in fluid communication with the working fluid circuit and the at least one fluid bearing.

17. A turbine-generator assembly comprising a turbine according to claim 10, and a generator comprising a generator shaft with an external coupling element and a plurality of magnets mounted thereon to form part of a magnetic coupling, the generator being connected to the turbine by means of the magnetic coupling.

18. The turbine-generator assembly according to claim 17, wherein the magnetic coupling constitutes a magnetic gear having a non-unity gear ratio between the turbine shaft and the generator shaft.
